(19) United States
(12) Patent Application Publication
(10) Pub. No.: US 2015/0274912 A1
(43) Pub. Date: Oct. 1, 2015

(54) METHOD FOR PRODUCING PARTS MADE OF THERMOSETTING COMPOSITE BY LAYING OF FIBERS OF PREIMPREGNATED MATERIAL

(71) Applicant: AIRBUS GROUP SAS, Paris (FR)

(72) Inventors: Frédérick Cavaliere, Montigny Le Bretonneux (FR); Alain Renoncourt, Malakoff (FR); Patrice Lefebure, Orvault (FR)

(21) Appl. No.: 14/432,751

(22) PCT Filed: Oct. 8, 2013
(86) PCT No.: PCT/FR2013/052390

§ 371 Date: Mar. 31, 2015

(30) Foreign Application Priority Data
Oct. 8, 2012 (FR) 1259551

(51) Int. Cl. C08J 5/24; B32B 5/02; B29C 43/30

(52) U.S. Cl. CPC C08J 5/24; B29C 43/305; B32B 5/02; B29L 2009/00

(57) ABSTRACT

A process for fabricating a partially polymerized prepreg material. Fibers are impregnated with thermosetting resin. The resin is partially polymerized to a degree of polymerization between 10% and 60%. The thermosetting composite parts are produced by placement of fibers of the prepreg material. The material is laid-up in the form of rovings and heated at a temperature above the glass transition temperature of the prepreg state. The laid-up material is pressed and cooled to return to a temperature below the glass transition temperature of the prepreg state. The temperatures and the pressure are determined so that the part obtained has a void content of less than 4% by volume.

### RELATED APPLICATIONS

This application is a §371 application from PCT/FR2013/052390 filed Oct. 8, 2013, which claims priority from French Patent Application No. 12 59551 filed Oct. 8, 2012, each of which is herein incorporated by reference in its entirety.

### TECHNICAL FIELD OF THE INVENTION

The present invention relates to the field of thermosetting composite parts, and more particularly to a process for fabricating such parts by placement of fibers of partially polymerized prepreg material.

The present invention relates in particular to aeronautical composite parts and in particular any aircraft or helicopter structural part: fuselage, wing, nose cone, radome, vertical stabilizer, horizontal planes, helicopter airframe, blades, shrouded tail rotor, etc., but may also be extended to all thermosetting composite parts outside of the aeronautical field.

### BACKGROUND OF THE INVENTION

Currently, thermosetting composite parts are produced by fiber placement and use fibre rovings prepregged with resin in the non-polymerized state. These materials are generally stored at −18° C. in order to keep the resin at a degree of polymerization of less than 20%. Automated fiber placement (AFP) drape forming is widely used for complex parts and/or large-sized parts. The drape forming of the plies is carried out automatically. This drape forming is carried out via a mechanical head equipped with means for supplying and cutting the rovings, heating means and pressure means. The material is heated just before lay-up in order to increase the tackiness of the resin during the drape forming of the various fibers one on top of the other. The application of pressure to the plies is carried out via a pressure roll.

The drawback of these types of techniques is that they require intermediate vacuum compactions to be carried out as soon as a few layers are draped, for example every 5 or 6 layers. Indeed, despite the application of pressure during the drape forming, air is trapped during the drape forming. The intermediate compaction thus makes it possible to partly evacuate this air trapped between plies during the drape forming and to ensure correct holding of the various layers of the laminate to one another (action of the tack).

In order to overcome this type of drawback, certain processes use a pressure roll equipped with a sonotrode (UTL or Ultrasonic Tape Laying technique) in order to reduce the amount of air trapped during the drape forming by virtue of the ultrasounds emitted. However, the use of such a process decreases the lay-up rate and therefore reduces the productivity, and does not completely prevent the need for intermediate compactions.

Intermediate compactions are very costly in terms of time, complicate the process and the device used, and do not eliminate the need for polymerizing the part under pressure in an autoclave in order to ensure a good performance of the material of the final part.

### OBJECT AND SUMMARY OF THE INVENTION

The object of the present invention is therefore to overcome one or more of the drawbacks of the prior art by proposing a process for producing thermosetting composite parts by placement of fibers of prepreg material in the form of rovings which makes it possible to reduce the amount of air trapped during the drape forming without adversely affecting the lay-up rate, to eliminate the intermediate compactions and makes it possible in certain cases to carry out the final polymerization step without an autoclave.

For this, the present invention proposes a process for fabricating a partially polymerized prepreg material, said process comprising a step of impregnating fibers with thermosetting resin and a step of partially polymerizing the resin to a degree of polymerization of between 10% and 60%. Preferably, the partial polymerization of the resin is carried out to a degree of polymerization of between 20% and 50%.

According to various embodiments of the invention, the step of impregnating the fibers is carried out before or after the step of partially polymerizing the resin.

The invention also relates to a partially polymerized prepreg material, capable of being obtained by the process as described above. Such a material may be stored at ambient temperature, of the order of 20° C., for a long period of the order of several months.

According to one embodiment of the invention, the material consists of a multilayer of partially polymerized resins.

The invention also relates to a process for producing thermosetting composite parts by placement of fibers of the partially polymerized prepreg material described above, said process comprising:
a step of laying-up the material in the form of rovings,
a step of heating the laid-up material, at a temperature above the glass transition temperature of the prepreg state in question,
a step of pressing the laid-up material,
a step of cooling the laid-up material, making it possible to return to a temperature below the glass transition temperature of the prepreg state in question,

the temperatures of the heating and cooling steps and the pressure of the pressing step being determined so that the part obtained has a void content of less than 4% by volume.

According to various embodiments of the invention, the heating step is carried out immediately before the pressing step or simultaneously with the pressing step.

According to various embodiments of the invention, the cooling step is carried out immediately after the pressing step or simultaneously with the pressing step.

According to one embodiment of the invention, a final polymerization step is carried out in an oven.

According to one embodiment of the invention, the process comprises a first step of storing the prepreg material at ambient temperature.

The invention also relates to a thermosetting composite part capable of being obtained by a process as described above.

### BRIEF DESCRIPTION OF THE DRAWINGS

The following detailed descriptions, given by way of example, and not intended to limit the present invention solely thereto, will be best be understood in conjunction with the accompanying figures:

FIGS. 1, 2 and 3 illustrate the changes in the following parameters as a function of time:

FIG. 1: change in the degree of pre-polymerization before and after lay-up;

FIG. 2: change in the pressure, temperature and viscosity parameters during the lay-up; and

FIG. 3: change in the degree of polymerization during the final polymerization cycle.

### DETAILED DESCRIPTION

The present invention relates to a process for producing thermosetting composite parts by drape forming of plies of a novel prepreg material that has previously undergone a partial polymerization cycle, also referred to as a semi-cured prepreg material.

More specifically, the invention relates to the placement of rovings of a novel prepreg material that has previously undergone a partial polymerization cycle. The rovings are in narrow tape form which enables independent control of the laying-up and of the cutting of the rovings, and makes it easier to obtain more complex shapes. Thus, the fibers in roving form are easily handled and enable precise placement. The rovings used within the context of the present invention, prepregged with partially polymerized resin, have a rigid and dry, non-tacky appearance. The resin is in the solid state. The relaxation at ambient temperature of such a material is very low, that is to say that a very small reduction in the time of the internal stresses under a constant strain is observed. This relaxation is even lower when the degree of pre-polymerization is high.

The placement step, which is also a drape forming step, carried out in the process according to the invention, is preferably automatic.

The automatic placement consists in using a machine which itself carries out the simultaneous laying-up of several rovings and the cutting of these rovings.

During the placement step, the material is heated simultaneously so as to enable the attachment of the rovings to one another, and pressed by a compression means and for example by a roll or any other equivalent means.

More specifically, the heating is carried out at the interface of the rovings already laid up and of the rovings laid up at the time of the placement, over the entire interface.

The heating is carried out by any method known to a person skilled in the art and for example by torch, radiant, laser, infrared, etc. heating.

According to one variant of the invention, the heating is carried out via a compression means that exerts the pressure on the rovings.

According to one variant of the invention, a second heating is carried out via a second compression means or roll used after the passage of the first roll.

During heating, the viscosity state of the prepreg material is very close to that of a non-polymerized material. This state enables the attachment of the rovings to one another.

During the placement, the pressure exerted by the compression means is greater than 1×10⁵ Pa (1 bar) and therefore makes it possible to eliminate the intermediate compactions carried out at ambient temperature under vacuum, since via the process according to the invention, at ambient temperature the laminate is in a rigid and dry state and does not creep.

According to one embodiment of the invention, the pressure may be relatively similar to, or even greater than, that customarily applied in an autoclave, and preferably greater than 7×10⁵ Pa (7 bar). During the polymerization cycle, the vacuum must be attained before the temperature rise so as not to degrade the very low void content of the material.

The material is cooled immediately after the passage of the compression means or roll in order to set the material. The heating/pressure and pressure/cooling pairings of the prepreg material are defined so that the plies have the necessary attachment to one another after the passage of the roll. The hot pressing combined with a good melt flow of the resin, with the setting under pressure and with the very low relaxation of the resin once cooled makes it possible to obtain and maintain a very low void content.

When the drape forming step is completed, the final polymerization of the material forming the part obtained may be carried out in an oven if the void content is low enough; and in an autoclave if this is not the case.

The various parameters of the process and more specifically:
the degree of pre-polymerization of the semi-cured material in question,
the heating temperature of the material at the time of the drape forming which must be greater than the glass transition temperature of the semi-cured material in question, the glass transition temperature being defined as representing the temperature range across which the material passes from a rubbery state to a rigid, solid, glassy state, this glass transition temperature of the semi-cured material is preferably between 20° C. and 150° C. This temperature depends on the degree of pre-polymerization,
the pressure of the roll,
the temperature on leaving the roll, which must be very rapidly below the glass transition temperature of the semi-cured material in question,
the type of heating, which may be laser, infrared, hot air or other,

are determined so that the laminate obtained has a void content of less than or equal to 4% by volume. The absence of voids or a very low void content allows, in certain cases, a final polymerization in an oven, instead of carrying out a polymerization in an autoclave as is the case for the prior art techniques. If the semi-cured laminate is placed under vacuum during the final polymerization, the level of vacuum required may preferably be attained before the temperature exceeds the glass transition temperature of the semi-cured material in question.

More specifically, the heating temperature during the drape forming is above the glass transition temperature of the semi-cured material and below or equal to 250° C.

The glass transition temperature is measured by differential calorimetry analysis (DSC) according to the ISO 11357-2 standard, following the inflection point method. This Tg measurement is carried out on the partially polymerized prepreg material before drape forming.

The cooling temperature is below the glass transition temperature of the semi-cured material and above or equal to 20° C.

The control of the discrete attachment is made possible by the fact that the material used within the context of the process according to the invention is semi-cured.

Within the context of the invention, a “partially polymerized” or “semi-cured” material is understood to mean a material that has undergone a partial polymerization cycle and the degree of polymerization of which is between 10% and 60%, and preferably between 20% and 50%. Preferably, the degree of polymerization should remain below the gel point of the material. The degree of polymerization is also selected in order to enable the storage of the material at ambient temperature, of the order of 20° C., for a long period of the order of several months, or even years.

The degree of polymerization is measured by differential calorimetry analysis (DSC) according to the ISO 11357-5 standard. The degree of polymerization is calculated before drape forming from the reaction enthalpy of the partially polymerized material tested and from the reaction enthalpy of the same material, non-polymerized and acting as a reference.

The novel partially polymerized prepreg material used in the process of the present invention may be obtained by various methods of fabricating the material.

A first method of fabricating the material consists in firstly carrying out a conventional prepregging of carbon or glass fibers or any other fibers that can be used for the production of structures. The impregnating resins could be of epoxide, polyimide, cyanate or benzoxazine type, or any other type of thermosetting resins that can be used for producing a prepreg for the fabrication of structures. These impregnated fibers are then placed in separators and wound around a mandrel. The bobbins formed by the wound prepreg fibers are then semi-cured, that is to say partially polymerized, with temperatures which depend on the reactivity of the resin in question but which are between 50° C. and 180° C. with times that may be between a few minutes to a few hours. It is necessary during this process to verify that the separators are compatible with the semi-curing temperatures, that they do not pollute the prepreg during the semi-curing phase, that the degree of polymerization is indeed the same throughout (+/−epsilon). This process has the advantage of not modifying the prepreg production method that is already known very much.

Another method of fabricating the material consists in prepregging fibers in resin that has previously been partially polymerized and maintained at a temperature above the glass transition temperature of the semi-cured material during the impregnation phase, calendering phase, and if necessary during the phase of inserting thermoplastic nodules on the surfaces of the prepreg if the latter requires it. Preferably, the material is maintained at the lowest viscosity temperature. This process has the advantage of a good control of the degree of partial polymerization, makes it possible to retain a good alignment of the fibers, makes it possible to introduce fewer stresses into the semi-cured material which may facilitate handling thereof, and above all makes it possible to eliminate the separators.

Another method of fabricating the material, which is a mixture of the two preceding methods, consists in prepregging fibers in a bath of optionally partially pre-polymerized resin. These prepreg fibers then undergo a semi-curing cycle in order to bring the prepreg material to the required degree of polymerization, before or after winding on a mandrel.

In all the methods of fabricating the material, the partial polymerization is carried out at high temperature or in any other manner that enables the polymerization, and for example under the action of microwaves, electron-bombardment polymerization, etc.

With these types of methods of fabricating the material, the energy expended for the semi-curing of the material (a few hours at temperatures of 50° C. to 180° C.) is much lower than the energy expended for storing it at −18° C. over long durations that may stretch to several months as is the case in the prior art.

According to one variant, the prepreg material consists of a multilayer of resins, that is to say several resins, selected from the types of resins described above. The resins are either resins of different types that are compatible with one another with an identical degree of polymerization, or an identical type of resin with different degrees of polymerization, preferably within the range 10%-60%, or a mixture of resins of different types and with different degrees of polymerization.

According to one embodiment, a multilayer prepreg is produced with a first resin with a degree of polymerization that is sufficiently advanced to ensure a good performance of the material at the core of the ply, it being possible for the degree of polymerization in this case to be greater than 60%, and a second resin at the surfaces of the ply in order to improve the drapability. A better fluidity of the resin at the drape forming temperature favoring a good spreading of the resin and therefore a reduction in the voids between the plies. Such a material is for example produced by successive impregnations in different resin baths.

According to one embodiment of the invention, the surface appearance of the material is smooth, which favors the non-creation of voids during the drape forming.

According to one embodiment of the invention, the material has particular features and for example channels of various shapes, which are not very deep or which pass through the thickness, are parallel or crossed, with a smooth surface between the channels, so as to promote/facilitate the drainage of air should voids remain between the plies.

The partially polymerized material used within the context of the invention is thus a material that is stable over time, can be stored at ambient temperature and the polymerization of which can be reactivated simply at any moment, for example by heating.

This material has:
a degree of impregnation of between 25% and 75% by volume of resin,
a degree of polymerization of between 10% and 60%, irrespective of its presentation,
a presentation that enables the manual handling or machine-handling thereof,
a surface finish that facilitates the elimination of voids and is therefore suitable for the drape forming process according to the invention.

According to one variant, the process for producing thermosetting composite parts according to the invention thus comprises a step of fabricating the prepreg and partially polymerized material as described above.

The process for producing thermosetting composite parts according to the invention thus has the following advantages:
the partially polymerized resin of the prepreg plies has a locally rigid and dry, non-tacky appearance, and is stored at ambient temperature,
the intermediate compactions at ambient temperature are eliminated,
the semi-cured laminate produced with the process according to the invention is rigid and stable over time at ambient temperature, that is to say that the degree of polymerization does not change. The laminate may thus be stored at ambient temperature;
the fact of partially polymerizing the material makes it possible to evacuate the solvents during this partial polymerization phase, even with materials impregnated by hot-melt extrusion coating,
the fact that the material is already partially polymerized makes it possible to adapt the final polymerization cycle with a possible reduction in the duration,
during the final polymerization cycle, the fact of having produced a semi-cured laminate with very few voids may allow treatment in an oven rather than in an autoclave.

According to one variant of the invention, depending on the material used, on the degree of pre-polymerization and on the void content of the laminate in question, the treatment in an oven may be carried out without an air vacuum.

### Exemplary Embodiment of the Invention

A curved panel of fuselage type is produced according to the following steps:
pre-polymerization of a class 180 carbon/epoxy material to a degree of polymerization of around 40%;
storage of the material at ambient temperature of around 21° C.;
lay-up of the material in the form of rovings, 12 crossed plies of carbon/epoxy, grade 134 g/m²;
during the lay-up, heating of the material by a laser over the entire interface which will be pressed by the roll, at a temperature of the order of 150° C.;
the heating phase is immediately followed by a pressing phase using a roll;
the pressure of the roll during the pressing phase is close to 7 bar;
the cooling takes place partly during the pressing and is completed immediately after the passage of the roll;
final polymerization at a temperature of 180° C. for 2 h.

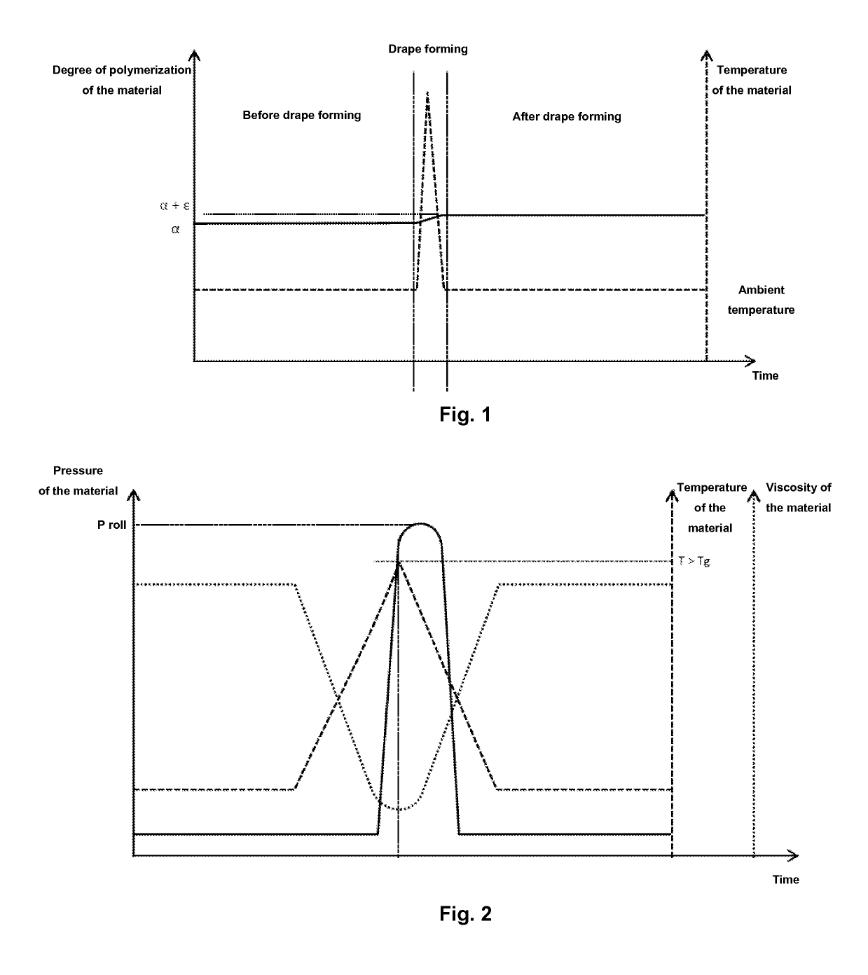

FIG. 1 illustrates the very small increase in the degree of pre-polymerization of the material during the lay-up. If the degree of polymerization before lay-up had a value “alpha”, the value after lay-up will be “alpha+epsilon”. The lay-up phase is represented by the temperature peak.

FIG. 2 illustrates the following phases:
the increase in temperature that takes place immediately before the passage of the roll,
at the same time as the heating, the viscosity of the material decreases. The resin becomes tacky again, or even liquid,
once the material has reached a temperature above the glass transition temperature, the roll presses the material (increase in the pressure on the material, the departure of the roll is represented by the drop in pressure),
during the pressing phase, it is possible to start the cooling phase,
at the same time as the cooling, the viscosity of the material increases until the material becomes solid, rigid and dry again.

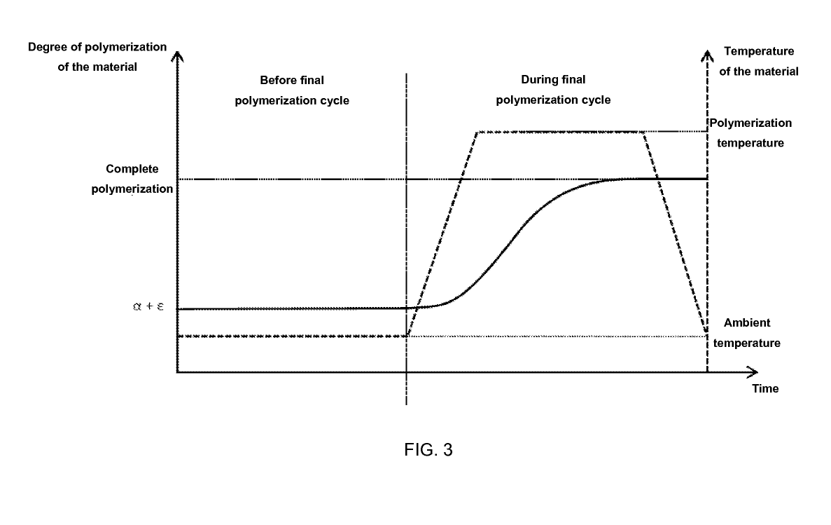

FIG. 3 illustrates the final polymerization phase. The part that has been drape formed has a degree of polymerization of “alpha+epsilon” which has not changed since the lay-up. Maintaining the part at the polymerization temperature for several hours makes it possible to completely polymerize the part.

1. A process for fabricating a partially polymerized prepreg material, comprising the steps of: impregnating fibers with a thermosetting resin, and partially polymerizing the thermosetting resin to a degree of polymerization between 10% and 60%.

2. The process as claimed in claim 1, wherein the partial polymerization of the thermosetting resin is carried out to a degree of polymerization between 20% and 50%.

3. The process as claimed in claim 1, wherein the step of impregnating the fibers is carried out before the step of partially polymerizing the thermosetting resin.

4. The process as claimed in claim 1, wherein the step of partially polymerizing the thermosetting resin is carried out before the step of impregnating the fibers.

5. A partially polymerized prepreg material obtained by impregnating fibers with a thermosetting resin, and partially polymerizing the thermosetting resin to a degree of polymerization between 10% and 60%.

6. The material as claimed in claim 5, comprising a multilayer of partially polymerized resins.

7. A process for producing thermosetting composite parts by placement of fibers of a partially polymerized prepreg material obtained by the process of claim 1 and further comprising the steps of:
laying-up the partially polymerized prepreg material in the form of rovings;
heating the laid-up material, at a temperature above a glass transition temperature of a prepreg state;
pressing the laid-up material;
cooling the laid-up material, to return the laid-up material to a temperature below the glass transition temperature of the prepreg state; and
determining temperatures of the heating and cooling steps and a pressure of the pressing step so that a thermosetting composite part obtained has a void content less than 4% by volume.

8. The process as claimed in claim 7, wherein the heating step is carried out immediately before the pressing step.

9. The process as claimed in claim 7, wherein the heating step and the pressing step are carried out simultaneously.

10. The process as claimed in claim 7, wherein the cooling step is carried out immediately after the pressing step.

11. The process as claimed in claim 7, wherein the pressing step and the cooling step are carried out simultaneously.

12. The process as claimed in claim 7, further comprising the step of performing a final polymerization in an oven.

13. A thermosetting composite part obtained by a process as claimed in claim 7.
